(19) United States
(12) Patent Application Publication
(10) Pub. No.: US 2010/0076633 A1
(43) Pub. Date: Mar. 25, 2010

(54) AUTOMATIC SYSTEM FOR CONTROLLING THE PROPULSIVE UNITS FOR THE TURN OF A BOAT

(76) Inventors: Marco Murru, Abbasanta (Oristano) (IT); Massimiliano Cotterchio, Savona (IT); Simone Bruckner, Viareggio (Lucca) (IT)

Correspondence Address: Steinfl & Bruno, 301 N Lake Ave Ste 810, Pasadena, CA, 91101, US

(21) Appl. No.: 12/598,735

(22) PCT Filed: Nov. 6, 2007
(86) PCT No.: PCT/IB07/54485

§ 371 Date: Nov. 3, 2009

(30) Foreign Application Priority Data
May 4, 2007 (IT) T02007A000304

(51) Int. Cl. G06F 19/00

(52) U.S. Cl. 701/21

(57) ABSTRACT

Automatic control system for the turn of a boat equipped with two propulsive lines, each line comprising a propulsion device (6a, 7a), an engine (4, 5), a reversal device (6, 7), and a control hand lever (1, 2) suitable to generate a forward gear request signal (8), a reverse gear request signal (9), and a boat acceleration request signal (10). The system further comprises devices generating a turn request signal (15) and a control unit (3) for the above-mentioned engines (4, 5) which is arranged to acquire the signals (8-10) from the control hand levers (1, 2) and the turn request signal (15), and arranged to generate, as a function of said signals (8-10, 15), two virtual speed signals (17, 18) indicative of the thrust to be developed by the propulsive devices (6a, 7a). The control unit (3) is further arranged to compute the virtual speed signals (17, 18) so as to generate two engine acceleration-deceleration signals (13a, 13b), indicative of the absolute value of the acceleration required for each engine (4, 5), and four drive signals, respectively two forward gear reversing gear signals (11a, 11b) and two reverse gear reversing gear signals (12a, 12b), to be applied to the reversal devices (6, 7) and indicative of the gear direction required for the associated engines (4, 5).

The present invention relates to an automatic system for the control of the propulsive units for the turn of a boat.

More particularly, the invention relates to an automatic control system which is able to automatically modulate the operation of the two engines in order to increase the manoeuvrability of a boat, as defined in claim 1.

Turn operations are conventionally performed by acting uniquely upon the rudder.

A difficulty encountered by the unskilled operator which is related to the performing of manoeuvre operations is when the boat has to be manoeuvred at a low speed, for example while being in the port. In such a case, since the boat rudders are poorly efficient at low speeds, conventional systems provide for the operator to separately use and actuate the two engines being the two different propulsive lines of the boat in order to perform manoeuvres in narrow spaces.

Some systems facilitate this kind of manoeuvre thanks to a movable joystick which allows the user to intuitively drive the boat.

An object of the present invention is to propose a control system for the turn of a boat which is able to improve performance in terms of manoeuvrability of the boat, both at high speed and low speed.

It is desired to provide a system which, at high speed, allows the user to perform curves with narrower radiuses, the speed kept equal, than with conventional systems.

It is further desired that, at low speed, the system allows the user to use the rudder wheel in order to perform manoeuvre operations of the boat.

These and other objects are achieved by an automatic system for controlling the propulsive units for the turn of a boat, the main features of which are defined in claim 1.

Particular embodiments are the object of the dependent claims.

Further characteristics and advantages of the invention will appear from the detailed description below, which is merely given by way of a non-limiting example, with reference to the annexed drawings, in which:

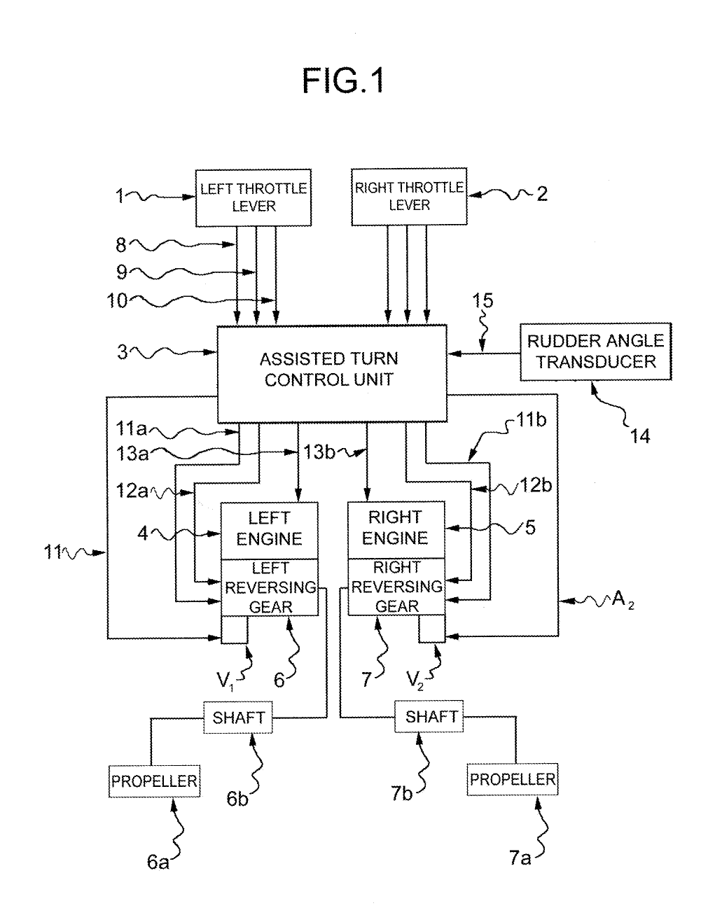

FIG. 1 is a schematic representation of the propulsion system of a boat comprising a control unit according to the invention;

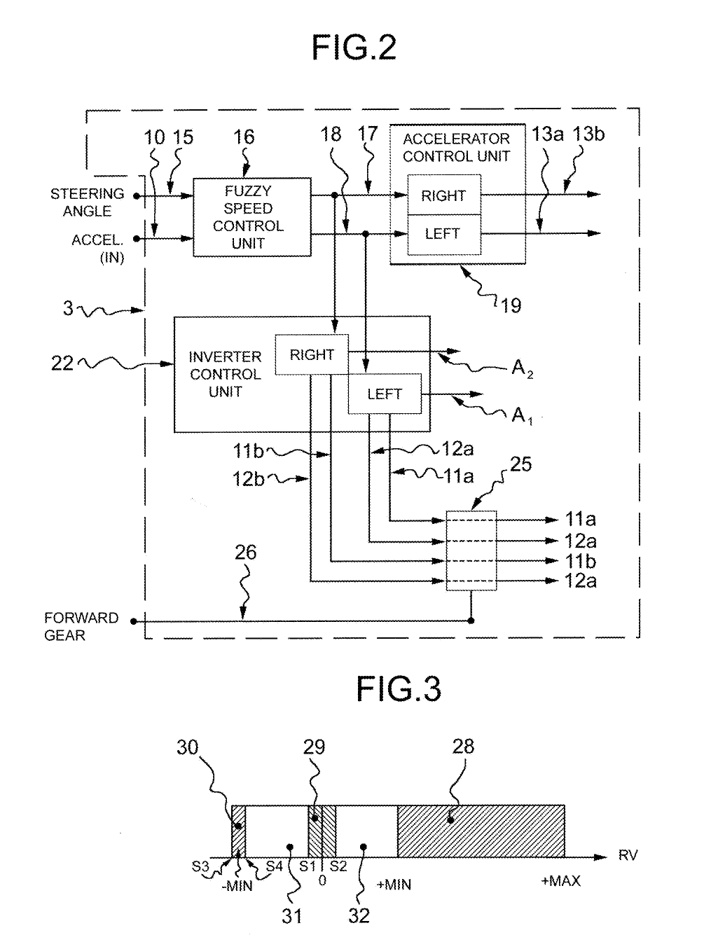

FIG. 2 is a scheme of the control unit according to the invention;

FIG. 3 is a diagram of the regions of membership of the virtual speed signal;

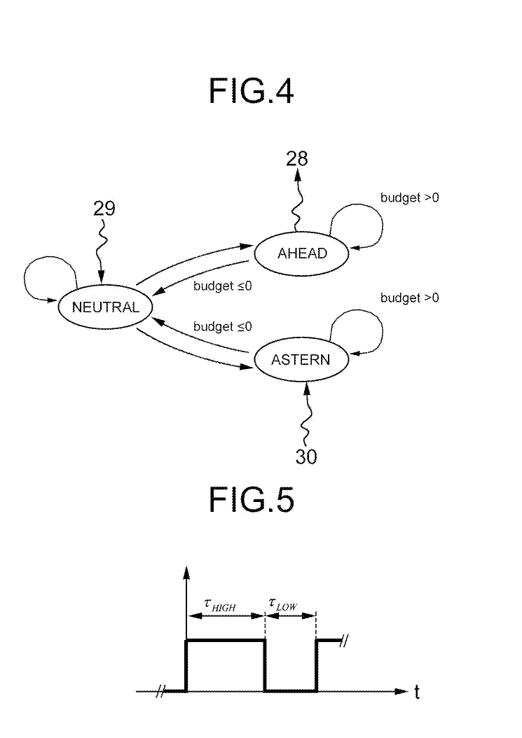

FIG. 4 is a finite state machine representing the control of the boat reversers; and

FIG. 5 is a timing diagram of the impulse applied to the reversing gears.

In FIG. 1 a scheme of the propulsion system of a boat is represented comprising two different (starboard and port side) propulsive lines, composed each by an engine, a reverser gear, a drive shaft, and a propeller. Each propulsive line is controlled, in the conventional use, by a throttle lever which modulates the engine acceleration and controls the associated reverser gear, by selecting the gear engagement (forward gear, neutral, reverse gear).

In a variant embodiment not illustrated in the figures, the boat propulsion system is a hydro jet drive type. In this case, the two propulsive lines are composed by an engine, a hydro jet pump and a reversal baffle. The selection of forward gear, reverse gear or neutral is therefore carried out by controlling the reversal baffle located downstream the nozzle of the hydro jet pump which is able to reverse the direction of part of the flow, by adjusting forward or rearward thrust direction. The turn operation, instead, is typically carried out either via a direction baffle which deviates the water flow rightwards or leftwards, or through directionable nozzles.

The propulsion system such as represented in FIG. 1 comprises a left throttle lever 1 and a right throttle lever 2, said throttle levers 1 and 2 being connected to a control unit 3. Said control unit 3 is connected respectively to a left engine 4 and to a right engine 5, to which respectively a left reverser gear 6 and a right reverser gear 7 are associated. The reversers 6 and 7 are then connected to respective propellers 6a and 7a through respective drive shafts 6b and 7b.

Each of the two left 1 and right 2 throttle levers is arranged to send a forward gear request signal 8, a reverse gear request signal 9 and a boat acceleration request signal 10 to the control unit 3.

The control unit 3 is arranged to generate, according to modalities which will be described below, two forward gear reverser signals 11a and 11b and two reverse gear reverser signals 12a and 12b, said signals 11a, 11b, 12a, 12b being associated in pairs to the left 6 and right 7 reversers, respectively. Furthermore, the control unit 3 is adapted to generate two engine acceleration-deceleration signals 13a and 13b, which are associated to the left 4 and right 5 engines, respectively.

In the case of a hydro-jet system, the forward gear reverser 11a and 11b and reverse reverser 12a and 12b signals are used in order to control the reversal baffle instead of the reverser.

The control unit 3 is further arranged to receive, by a transducer 14 of the rudder angle (γ), a turn request signal 15 representative of the turn angle as desired by the user.

The control system of the assisted turn is thus interposed between the control of the left 1 and right 2 throttle levers and the propulsive apparatus, and it provides that, depending on the required turn angle, the two left 4 and right 5 engines (and the associated left 6 and right 7 reversers) are controlled in a differentiated manner, so as to facilitate the manoeuvre. Therefore, the control system allows managing the two engines 4 and 5 also as a function of the required turn angle.

The management logic of the system according to the invention provides that both left 4 and right 5 engines can be modulated using only one throttle lever, either the left throttle lever 1 or the right throttle lever 2 according to the design selections. Said throttle lever, which is indicated as the reference throttle lever herein below, is arranged to provide all the information and signals relating to the overall thrust which is desired for the boat. The differentiated control to the two propulsive lines is established by the control unit 3.

However, the non-reference throttle lever is monitored by the control unit 3 in order to implement safety logics. For example, it is possible to bypass the control unit of the assisted turn system in order to manoeuvre the boat in the conventional manner, by means of the control by the two throttle levers.

FIG. 2 schematically illustrates the operation of the control unit 3 which uses the turn request signal 15 and the boat acceleration request signal 10 coming from the reference throttle lever as input signals. Said signals are used by a fuzzy speed control unit 16 which generates, according to fuzzy rules, known per se and described herein below, a first right virtual speed signal (RV) 17 and a second left virtual speed signal (RV) 18, associated with each of the two left 4 and right 5 engines and relative left 6 and right 7 reversers.

Said virtual speed signals 17 and 18 represent the thrust that the propellers 6a and 7a have to generate in order to properly distribute the overall thrust of the boat between the two propulsive lines. The virtual speed signals 17 and 18 are therefore linked to the engine operational speed and desired turn angle 15.

The engine operational interval can range between a minimum value and a maximum value, while the virtual speed signals 17 and 18 can range between a negative value −MIN (corresponding to the engaged reverse gear with minimum running engine) and a positive value +MIN (corresponding to the engaged forward gear with minimum running engine), to a maximum positive value +MAX in the case of forward gear engagement and operation of the accelerator. The null value of the virtual speed signals 17 or 18 corresponds to the neutral, i.e. a minimum running engine and reverser in the neutral.

Thereby, after the virtual speed signal 17 or 18 has been established to be assigned to each group composed by the engine 4 or 5 and the associated reverser 6 or 7, said groups are individually controlled.

In order to generate the two virtual speed signals 17 and 18, the fuzzy speed control unit 16 turns the boat acceleration request signal 10 and the turn request signal 15 to the signals which are representative of the control to be provided to the two engines 4 and 5 for the generation of the torques of said engines 4 and 5. This transformation process will be described in greater detail below.

At this stage, the two virtual speed signals 17 and 18 are sent to an accelerator control unit 19, associated with the left 4 and right 5 engines, which outputs, according to modalities to be described herein below, the engine acceleration-deceleration signals 13a and 13b, which represent the absolute value for the acceleration and/or the deceleration to be provided to each of the engines 4 and 5.

The two virtual speed signals 17 and 18 are further sent to a reverser gear control unit 22 associated to the left 4 and right 5 engines, which outputs, according to modalities to be described herein below, the forward gear reverser 11a and 11b and reverse gear reverser 12a and 12b signals for each of the reversers 6 and 7. Said forward gear reverser 11a and 11b and reverse gear reverser 12a and 12b signals are sent to a reverser enable unit 25 which, on the basis of an enable signal 26, sends them to the reversers 6 and 7. The enable signal 26 is sent by the reference throttle lever, and is activated when the forward gear is engaged; the forward gear reverser 11a and 11b and reverse gear reverser 12a and 12b signals are thus enabled only when the reference throttle lever sends the forward gear request signal 8 to the control unit 3. It should be noted that the actual gear engagement is performed by the control unit 3 by means of the forward gear reverser 11a and 11b and reverse gear reverser 12a and 12b signals, while the throttle lever only provides for the enabling.

The enable signal 26 is used in order to distinguish the minimum running engaged gear condition from the condition in which the neutral is engaged, since, in both cases, the engine is in a minimum speed operational condition.

Three engine operational speeds are defined on the basis of the boat acceleration request signal 10, in particular the Low, Medium and High speeds, which are implemented as fuzzy sets. The fuzzy sets are sets which are implemented according to a known logic such that a variable's condition of membership to a given set can be true, false, or can have intermediate truth degrees. The truth degree of such condition is called “degree of membership” of the fuzzy set.

A function of the turn request 15 and boat acceleration request 10 signals is associated to each operational speed. The fuzzy speed control unit 16 performs a combination weighed on the degree of membership to the fuzzy set of the three functions for each of the two left 4 and right 5 engines, thus obtaining the virtual speed signals 17 and 18 through a methodology (inference method of the Takagi-Sugeno type), known per se.

The functions are such that the values of the virtual speed signal 17 or 18 are less than or equal to the values of the boat acceleration request signal 10 for the inner engine as compared with the turn trajectory (starboard engine for the starboard turn, port side engine for the port side turn) and the values of the virtual speed signal 17 or 18 are greater than or equal to the values of the boat acceleration request signal 10 for the outer engine (starboard engine for the port side turn, port side engine for the starboard turn).

As the turn request signal 15 increases, in either turn trajectory, the difference between the virtual speed signals 17 and 18 will also increase. The dependence of said functions from the turn angle request signal 15 can be varied in order to increase or decrease the system sensibility to rudder angle (γ) variations.

In the case where a rudder angle (γ) is equal to zero, the virtual speed signals 17 and 18 are equal to each other, and are equal to the boat acceleration request signal 10.

In FIG. 3 a diagram shows the membership regions of each of the two virtual speed signals 17 and 18. Three regions (sectioned) are located:
Ahead 28, included between the +MIN and +MAX values of said signals 17 and 18,
Neutral 29, around the zero value of said signals 17 and 18, particularly in a region included between its pre-established thresholds S1 and S2;
Astern 30, around the −MIN value of said signals 17 and 18, particularly in a region included between two pre-established thresholds S3 and S4.

In the Ahead region 28, the forward gear is engaged, and it is only acted upon the accelerator; the engine operation ranges from its minimum value to its maximum value. In the Neutral region, the neutral is engaged, and it is not acted upon the accelerator; the engine operational speed is equal to its minimum value. In the Astern region 30 the reverse gear is engaged and it is acted upon the accelerator. In this case, since the virtual speed signal 17 or 18 is inferiorly limited to −MIN, the engine operation is equal to its minimum value, but it could virtually extend to its maximum value.

In FIG. 3 two intermediate regions 31 and 32 are further illustrated, in which there is a situation of variable operation of the engine between the condition of “turn off” (neutral) and its minimum value with the forward gear or the reverse gear. An engagement and disengagement of the gear are then performed, the reverse gear for the region 31 and the forward gear for the region 32, respectively. Such gear engagement or disengagement is performed by the assisted turn control unit 3, which either sends or does not send the forward gear reverser 11a and 11b and reverse gear reverser 12a and 12b signals to the reversers 6 and 7. In such cases, the reference throttle lever is always in the forward gear position (therefore the enable 26 is active), and the control unit 3, on the basis of the turn request signal 15, engages the gear on a reverser 6 or 7 according to the requirements.

The control unit of the reversers 22 acts independently on the two right and left propulsion lines by associating a state of the reversers 6 or 7 to the virtual speed signal 17 or 18. The reversing gear control unit 22 performs, for each of the two propulsion lines, respectively left and right, a finite state machine, representing the engines 4 and 5 operation, the states of which, corresponding to the above-mentioned Ahead, Neutral and Astern regions, are shown in FIG. 4. In this way, the reverser control unit 22 generates the forward gear reverser signals 11a and 11b and the reverse gear reversing gear signals 12a and 12b on the basis of the value taken by the virtual speed signals 17 and 18.

The transitions between the states are implemented by means of algorithms based on “budget”, so as to carry out a modulation of the reverser when the virtual speed signal 17 or 18 takes values belonging to the intermediate regions 31 and 32 of FIG. 3.

The “budget”-based algorithm is such that a state is entered when particular conditions occur on the virtual speed signal 17 or 18. When a state is “entered”, an initial value is assigned to an inner variable, called the “budget”.

The transition to the Ahead state takes place in the case where a virtual speed signal 17 or 18 is recorded which is greater than the pre-established threshold S2. In ideal conditions, i.e. in the case of reversers with null response time, such threshold would match with point 0. On the other hand, the transition to the Astern state takes place in the case where a virtual speed signal 17 or 18 is recorded which is lower than the threshold Si. Within the Ahead and Astern states, the “budget” variable is modified at each control cycle. In the Ahead state (forward gear), the “budget” variable is reduced in the case where the virtual speed signal 17 or 18 is less than the +MIN value, according to a pre-established formula which adjusts the decreasing rate Δbudget/Δt on the basis of the virtual speed signal 17 or 18.

In the Astern state (reverse gear), the “budget” variable is reduced in the case where the virtual speed signal 17 or 18 is higher than the −MIN value, according to a pre-established formula as described above. When the value of the “budget” variable turns to zero, the gear is disengaged, and the system switches to the Neutral state.

From the Neutral state, one switches again to the Ahead and Astern states, on the basis of the value taken by the virtual speed signal 17 or 18, in order to carry out the gear engagement, respectively the forward gear or reverse gear.

The “budget” variable is therefore modified as a function of the virtual speed signal 17 or 18 value, which changes with time according to the variations of the input signals, respectively the turn request signal 15 and the boat acceleration request signal 10, which are continuously monitored.

Since the reversers 6 and 7 have response times which are different from the accelerator (both due to mechanical reasons and to safety-related reasons), the virtual speed signals 17 and 18 variations cannot be immediately followed; the budget-based algorithm performs a low-pass filtration of such signals. Thereby, even though the virtual speed signal 17 or 18 undergoes sudden variations, the control of the reversers while respecting the timing thereof is nevertheless possible, as per specification.

In the transitions from a state to another, variable delays are further introduced, depending on the specifications of the reversers 6 and 7, calculated on the basis of the engine operational speed recorded in the last time interval. This allows increasing the actuation delay of the reversers 6 and 7 in the case when the engine is running at high speeds, therefore the boat is moving at a high speed.

In particular, when disengaging the gear, i.e. the “budget” variable turns to zero, one switches to the Neutral state with a greater delay than in the case where the engine is running at its minimum speed. This is done in order to allow the boat to slow down due to the friction against water, before performing the reversing of the gear.

Thereby, the reversers and the engine are protected against damage problems due to excessive mechanical stress.

Therefore, the use of a “budget”-based algorithm allows computing the propulsive energy which is required and supplied in the last reference time interval.

In FIG. 5 a timing diagram is shown of an actuation impulse applied to the reversers 6 or 7 in order to engage the forward gear or the reverse gear. The modulation of said impulse takes place by changing the duty cycle and the period, on the basis of the virtual speed signal 17 or 18, so as to modify the τ_{HIGH}/(τ_{LOW}+τ_{HIGH}) ratio, where τ_{HIGH} is the rise time and τ_{LOW} is the descent time. Said modulation is performed so as to respect the reversers timing even in the heaviest-duty use.

The equation correlating duty cycle to virtual speed signal 17 or 18 is as follows:

$$\frac{{τ}_{HIGH}}{{τ}_{LOW} + {τ}_{HIGH}} = \frac{\vert RV \vert}{MIN} \qquad ( 1 )$$

where RV is the instantaneous value of the virtual speed signal 17 or 18, and MIN is its minimum value.

Finally, the accelerator control unit 19 turns the virtual speed signals 17 and 18 to the engine acceleration-deceleration signals 13a and 13b, shown as R in the following equation:

$$R = \{ \begin{matrix}\vert RV \vert & se \vert RV \vert > MIN \\ min & se \vert RV \vert \leq MIN\end{matrix} \qquad ( 2 )$$

where RV is the virtual speed signal 17 or 18, and min is a value corresponding to the minimum operational speed of the engine, which, for example, can match with the +MIN value of the virtual speed signal 17 or 18. Such functionality is provided as independent for the left engine 4 and for the right engine 5.

In a variant embodiment of the invention, the reversers 6 and 7 are equipped with an adjustment valve, respectively a valve V1 and a valve V2 (see FIG. 1), which are arranged in order to adjust the torque ratio transferred by the engines 4 and 5 to the propellers 6a and 7a. In this case, the assisted turn control unit 3 sends a torque adjustment signal to each valve V1 and V2, a first adjustment signal A1 and a second adjustment signal A2, respectively. Said adjustment signals A1 and A2 range between 0 and 1, where zero corresponds to 0% torque transferred by the engine to the propeller, and 1 corresponds to 100% torque transferred by the engine to the propeller. The adjustment signals A1 and A2 are calculated by the reversing gear control unit 22 (see FIG. 2) according to the following relationship:

$$A = \{ \begin{matrix}\frac{\vert RV \vert}{MIN} & se \vert RV \vert < MIN \\ 1 & se \vert RV \vert \geq MIN\end{matrix} \qquad ( 3 )$$

where A respectively indicates the adjustment signal A1 or A2, RV represents the virtual speed signal 17 or 18, and MIN is its minimum value.

In this case, the use of the “budget”-based algorithm is not needed in order to change the engagement and disengagement of forward and reverse gears in the intermediate zones 31 and 32 of FIG. 3; in fact, the power adjustment is directly performed by the adjustment valve. In this case, the region 31 becomes an “Astern” region which is adjusted by the valve, and the region 32 becomes an “Ahead” region which is adjusted by the valve.

Of course, the principle of the invention remaining the same, the embodiments and implementation details may be widely changed as compared with what has been described and illustrated above by way of non-limiting example only, without however departing from the scope of the invention as defined in the annexed claims.

1. An automatic control system of propulsive units for turning of a boat equipped with right and left propulsive lines, each line comprising propulsion means, an engine, reversal means associated with said engine, and a control throttle lever adapted to generate gear and acceleration request signals including a forward gear request signal, a reverse gear request signal, and a boat acceleration request signal, the system comprising:
means generating a turn request signal, and
a control unit of the right and left engines arranged to acquire the gear and acceleration request signals, and a turn request signal,
said control unit being further arranged to generate, as a function of the gear and acceleration request signals and the turn request signal, two virtual speed signals indicative of a thrust to be developed by the propulsion means, and to process said virtual speed signals to generate:
two engine acceleration-deceleration signals, indicative of an absolute value of acceleration required for each of the right and left engines, and
four drive signals, including two forward gear reverser signals and two reverse gear reverser signals, to be applied to the reversal means and indicative of a gear direction for the respective right and left engines.

2. The automatic control system according to claim 1, wherein the control unit comprises a fuzzy speed control unit arranged to acquire the boat acceleration request signal and the turn request signal, and to generate the two virtual speed signals.

3. The automatic control system according to claim 1, wherein the control unit is arranged to assume a first operational condition in which:
at least one of the two virtual speed signals belongs to a first interval, included between a first positive value and a second positive value, and
the control unit continuously sends at least one forward gear reverser signal and sends at least one engine acceleration-deceleration signal.

4. The automatic control system according to claim 3, wherein the control unit is arranged to adopt a second operational condition in which:
at least one of the two virtual speed signals belongs to a second interval, ranging between a first threshold and a second threshold, said first and second thresholds being lower than said first positive value, and
the control unit inhibits at least one forward gear reverser signal and at least one reverse gear reverser signal, and inhibits at least one engine acceleration-deceleration signal.

5. The automatic control system according to claim 4, wherein the control unit is arranged to adopt a third operational condition in which:
at least one of the two virtual speed signals belongs to a third interval, ranging between a third threshold and a fourth threshold, said third and forth thresholds being lower than said first threshold, and
the control unit continuously sends at least one reverse gear reverser signal, and sends at least one engine acceleration-deceleration signal.

6. The automatic control system according to claim 5, wherein the control unit is arranged to adopt a fourth operational condition in which:
at least one virtual speed signal belongs to a first intermediate interval ranging between the fourth threshold and the first threshold, and
the control unit intermittently sends at least one reverse gear reversing gear signal and inhibits at least one engine acceleration-deceleration signal.

7. The automatic control system according to claim 6, wherein the control unit is arranged to adopt a fifth operational condition in which:
at least one virtual speed signal belongs to a second intermediate interval ranging between the second threshold and the first threshold, and
the control unit intermittently sends at least one forward gear reverser signal, and inhibits at least one engine acceleration-deceleration signal.

8. The automatic control system according to claim 1, wherein the control unit comprises an accelerator control unit arranged to receive said virtual speed signals and to generate the engine acceleration-deceleration signals.

9. The automatic control system according to claim 3, wherein said engine acceleration-deceleration signals are defined as:
$$R = \{ \begin{matrix}\vert RV \vert & se \vert RV \vert > MIN \\ min & se \vert RV \vert \leq MIN\end{matrix}$$
where R indicates each engine acceleration-deceleration signal, RV indicates each virtual speed signal, min indicates a minimum operational speed of the engine and MIN indicates the first positive value.

10. The automatic control system according to claim 5, wherein the control unit comprises a reverser gear control unit arranged to receive said virtual speed signals and to generate the forward gear reverser signals and the reverse gear reverser signals.

11. The automatic control system according to claim 10, wherein the reverser control unit is arranged to provide at least one three-state finite state machine, with states respectively corresponding to the first interval, the second interval, and the third interval, and wherein the forward gear reverser signals and the reverse gear reverser signals are implemented by performing transitions between said states through a “budget”-based algorithm.

12. The automatic control system according to claim 11, wherein said “budget”-based algorithm performs the transitions between the states on the basis of a value assumed by the virtual speed signals.

13. The automatic control system according to claim 10, wherein the control unit comprises a reverser enable unit arranged to receive the forward gear reverser signals and the reverse gear reverser signals from the reverser control unit, said reverser enable unit being further adapted to receive an enable signal from the control throttle levers, and arranged to send to the reversal means, on the basis of a value of said enable signal, said forward gear reverser and reverse gear reverser signals.

14. The automatic control system according to claim 10, wherein the reversal means comprise adjusting valve means and the reverser control unit is arranged to send respective adjustment signals to said adjusting valve means, said adjustment signals being representative of a torque ratio to be transferred from the engine to the propulsion means.

15. The automatic control system according to claim 14, wherein said adjustment signals are defined as:
$$A = \{ \begin{matrix}\frac{\vert RV \vert}{MIN} & se \vert RV \vert < MIN \\ 1 & se \vert RV \vert \geq MIN\end{matrix}$$
where A indicates each adjustment signal, RV indicates each virtual speed signal, and MIN indicates the first positive value.

16. The automatic control system according to claim 3, wherein the forward gear reverser signals and the reverse gear reverser signals are modulable impulses having a rise time τ_{HIGH} and a descent time τ_{LOW}, and said modulation is such that:
$$\frac{{τ}_{HIGH}}{{τ}_{LOW} + {τ}_{HIGH}} = \frac{\vert RV \vert}{MIN}$$
where RV is an instantaneous value of each virtual speed signal and MIN is the first positive value.
